(19) United States
(12) Patent Application Publication
(10) Pub. No.: US 2013/0335647 A1
(43) Pub. Date: Dec. 19, 2013

(54) STEREOSCOPIC DISPLAY OPTICAL DEVICE AND STEREOSCOPIC DISPLAY UNIT

(71) Applicant: Sony Corporation, Tokyo (JP)

(72) Inventors: Tetsuyuki Yoshida, Tokyo (JP); Yoshihisa Sato, Saitama (JP); Soya Araki, Kanagawa (JP)

(21) Appl. No.: 13/911,679

(22) Filed: Jun. 6, 2013

(30) Foreign Application Priority Data
Jun. 18, 2012 (JP) 2012-136905

(51) Int. Cl. G02F 1/1335

(52) U.S. Cl. CPC G02F 1/1335
USPC 349/15

(57) ABSTRACT

A stereoscopic display optical device includes: a display section; a parallax separation section disposed to face the display section; and a spacer section sandwiched between the display section and the parallax separation section, and extending along respective perimeters of the display section and the parallax separation section.

### BACKGROUND

The present disclosure relates to a parallax barrier type of stereoscopic display unit that enables stereoscopic display to be made, and a stereoscopic display device to be used in the stereoscopic display unit.

Self-luminous types of display apparatus, such as plasma displays or organic EL displays, and non-luminous types of display apparatus, such as liquid crystal displays, are known as current display apparatuses. Among these displays, liquid crystal displays include, for example, a liquid crystal display panel that acts as a light-transmission type of light modulation element, and a backlight apparatus that irradiates the liquid crystal display panel with illumination light. This liquid crystal display is configured to display a desired image on the liquid crystal display panel by controlling the transmittance of the liquid crystal display panel for the illumination light from the backlight apparatus.

In order to satisfy a recent request for the slim-down of display apparatuses, a structure has already been proposed, in which a light-guide plate is disposed in the rear of a liquid crystal display panel (or on the opposite surface of the liquid crystal display panel to the display surface thereof) and a light source of a backlight apparatus is disposed so as to oppose an outer surface of the light-guide plate.

On the other hand, recently, a stereoscopic display unit which employs a parallax barrier type has been developed. The parallax barrier type allows a viewer to view a stereoscopic image without wearing special glasses, that is, with naked eye. This stereoscopic display unit has a structure in which a parallax barrier is disposed, for example, in the front of a two-dimensional display panel (namely, between the display surface of the two-dimensional display panel and the viewer) while facing the two-dimensional display panel. The parallax barrier is typically structured by alternately arranging blocking sections and opening sections (slit sections) in a lateral direction. Here, each blocking section is configured to block display image light from the two-dimensional display panel, and each opening section is formed in a slit shape and is configured to allow the display image light to pass therethrough.

The above parallax barrier type realizes stereoscopic viewing by displaying parallax images for the stereoscopic viewing (or perspective images intended for a right eye and a left eye if the number of viewpoints is two) on a two-dimensional liquid crystal display panel while spatially separating the parallax images and subjecting the parallax images to parallax separation in the lateral direction with a parallax barrier. By setting, for example, a slit width of the parallax barrier appropriately, respective light beams of the different parallax images are incident on the right and left eyes of the viewer independently of each other through the slit sections, when the viewer views the stereoscopic display apparatus in a predetermined direction at a predetermined location.

In displaying a stereoscopic image properly, an interval between the parallax barrier and the liquid crystal display panel becomes very important. If the interval varies within a screen, the parallax images do not reach the right and left eyes of the viewer properly. In some cases, the displayed stereoscopic image may be deteriorated by generating moire fringes or causing pseudo stereoscopy. Therefore, a technique is proposed, in which a spacer made of a single glass plate is disposed in order to maintain an appropriate interval between a parallax barrier and a display panel, throughout a screen (for example, see Japanese Unexamined Patent Application Publication No. H03-119889).

### SUMMARY

Unfortunately, when the single glass plate is used as the spacer as described above, the thickness of the spacer is determined by a design-based interval between the parallax barrier and the display panel. With its certain thickness, the spacer may become excessively heavy and difficult to handle. Alternatively, it is possible to use a resin plate, such as acrylic plate, as the spacer. However, using a resin plate is undesirable, because the resin plate dimensionally changes with surrounding temperatures more greatly than a glass plate does, and has low dimensional accuracy in thickness.

It is desirable to provide a stereoscopic display optical device which reduces its weight while maintaining its stiffness, thereby exhibiting superior handleability without deteriorating a display performance, and a stereoscopic display unit which is equipped with this optical device.

A stereoscopic display optical device according to an embodiment of the present disclosure includes: a display section; a parallax separation section disposed to face the display section; and a spacer section sandwiched between the display section and the parallax separation section, and extending along respective perimeters of the display section and the parallax separation section.

A stereoscopic display unit according to an embodiment of the present disclosure is provided with a light source and a stereoscopic display optical device that displays a stereoscopic image by utilizing light from the light source. The stereoscopic display optical device includes: a display section; a parallax separation section disposed to face the display section; and a spacer section sandwiched between the display section and the parallax separation section, and extending along respective perimeters of the display section and the parallax separation section.

In both the stereoscopic display optical device and the stereoscopic display unit according to the above-described embodiments of the present disclosure, the spacer section is interposed between the display section and the parallax separation section that are arranged to face each other. Accordingly, by selecting a thickness of the spacer section as appropriate, an interval is secured properly between the display section and the parallax separation section. The spacer section extends along the respective perimeters of the display section and the parallax separation section, thereby creating a space sandwiched between the display section and the parallax separation section while maintaining definite stiffness.

With the stereoscopic display optical device and the stereoscopic display unit according to the above-described embodiments of the present disclosure, it is possible to realize an excellent parallax image by selecting the thickness of the spacer section as appropriate so as to properly secure the interval between the display section and the parallax separation section. Moreover, employing a hollow structure in which the space is provided between the display section and the parallax separation section makes it possible to reduce the weight in comparison with a structure in which a single plate is disposed between the display section and the parallax separation section.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is an exploded, perspective view illustrating an exemplary configuration of a stereoscopic display unit that is equipped with a stereoscopic display optical device according to a first embodiment of the present disclosure.

Parts (A) and (B) of FIG. 2 are a cross-section view and a plan view, respectively, of the stereoscopic display unit illustrated in FIG. 1.

FIG. 3 is a block diagram of the exemplary configuration of the stereoscopic display unit illustrated in FIG. 1.

FIGS. 4A and 4B are other schematic views illustrating exemplary operations of a display section and a parallax separation section illustrated in FIG. 1.

FIG. 5 is an explanatory schematic view of an effect of the optical device illustrated in FIG. 1.

FIG. 6 is a plan view illustrating a modification example of the stereoscopic display unit illustrated in FIG. 1.

Parts (A) and (B) of FIG. 7 are a cross-section view and a plan view, respectively, of an exemplary configuration of a stereoscopic display unit that is equipped with a stereoscopic display optical device according to a second embodiment of the present disclosure.

Parts (A) and (B) of FIG. 8 are a cross-section view and a plan view, respectively, of a modification example of the stereoscopic display unit illustrated in FIG. 7.

FIG. 9 is a cross-section view of a stereoscopic display unit as another modification example of the present technology.

### DETAILED DESCRIPTION

Hereinafter, some embodiments of the present disclosure will be described in detail, with reference to the accompanying drawings.

### First Embodiment

### (Overall Configuration of Stereoscopic Display Unit)

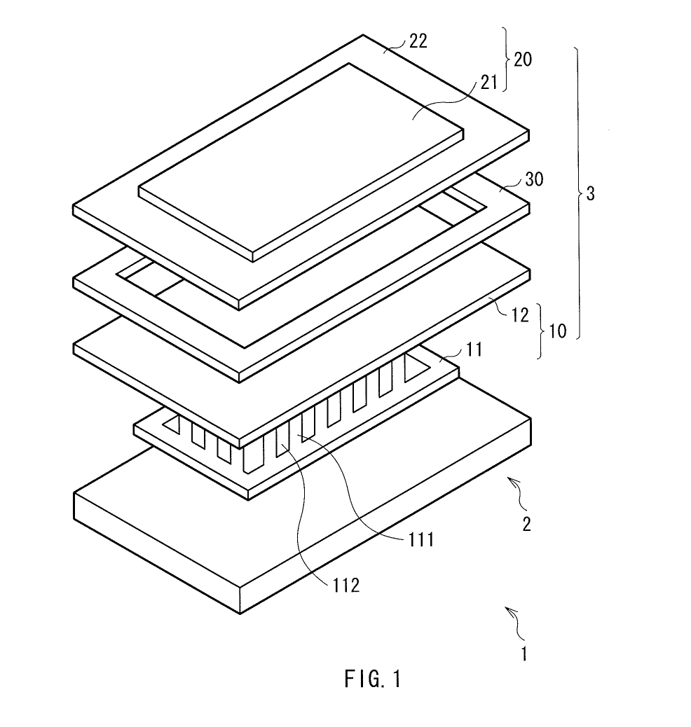

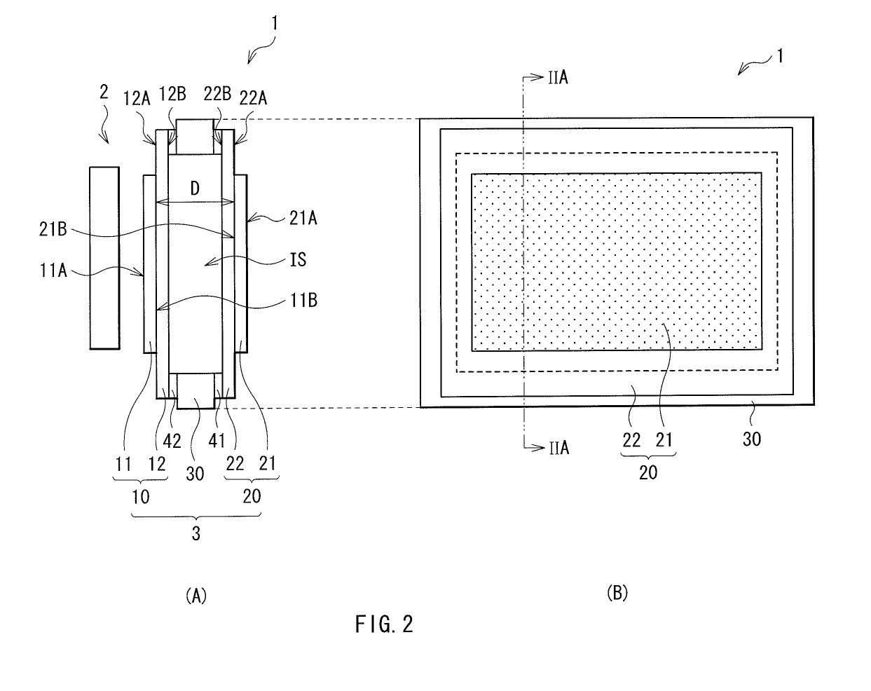

FIG. 1 is an exploded, perspective view illustrating an exemplary configuration of a stereoscopic display unit 1 according to a first embodiment of the present disclosure. Parts (A) and (B) of FIG. 2 are a cross-section view and a plan view, respectively, of the stereoscopic display unit 1 illustrated in FIG. 1. The cross-section view in Part (A) of FIG. 2 corresponds to a cross section taken along a cutting plane line IIA-IIA in Part (B) of FIG. 2 and viewed in a direction along an arrow of the cutting plane line IIA-IIA. The stereoscopic display unit 1 includes a backlight 2 and a stereoscopic display optical device 3 (hereinafter, referred to simply as an “optical device 3”). The optical device 3 is configured to display a stereoscopic image by utilizing light from the backlight 2.

The backlight 2 is a light source that emits image display light toward the optical device 3. The backlight 2 may be formed by, for example, arranging light emitting diodes (LEDs) on a side surface of a light-guide plate. Alternatively, the backlight 2 may be formed by arranging a plurality of cold cathode fluorescent lamps (CCFLs) or some other suitable lamps.

### (Structure of Optical Device 3)

The optical device 3 includes a parallax separation section 10, a display section 20, and a spacer 30. The parallax separation section 10 and the display section 20 are arranged to face each other, and the spacer 30 is sandwiched and held therebetween, as illustrated in FIGS. 1 and 2. The parallax separation section 10 includes a parallax barrier 11 and a transparent plate 12 that supports the parallax barrier 11. The display section 20 includes a liquid crystal display panel 21, and a transparent plate 22 that supports the liquid crystal display panel 21. Specifically, the optical device 3 may be configured by arranging the parallax barrier 11, the transparent plate 12, the spacer 30, the transparent plate 22, and the liquid crystal display panel 21 in this order, for example, in a direction away from a location adjacent to the backlight 2.

The transparent plates 12 and 22 function as reinforcing members that prevent the deformation of the parallax barrier 11 and the liquid crystal display panel 21. The transparent plates 12 and 22 are arranged parallel to each other while facing away from each other, and create a space IS (refer to Part (A) of FIG. 2) together with the spacer 30. Both the transparent plates 12 and 22 may be made of, for example, a transparent glass material, and desirably, this material may have as a low linear expansion coefficient as possible (for example, approximately 3.2±1.0e⁻⁶ 1/° C.). A reason for this is that the variation in an interval D between the parallax barrier 11 and the liquid crystal display panel 21, which is caused by the surrounding temperature change, is decreased so that stereoscopic display is made properly.

### (Configuration of Liquid Crystal Display Panel 21)

The liquid crystal display panel 21 is configured to display an image in a two-dimensional manner, and has a surface 21A on which the image is displayed and a surface 21B formed on the opposite side of the surface 21A, or facing the transparent plate 22. The liquid crystal display panel 21 emits display image light from the surface 21A to the viewer. The surface 21B may be fixed to a surface 22A of the transparent plate 22 with, for example, a transparent adhesive or the like. A perimeter of a surface 22B of the transparent plate 22 which is located on the opposite side of the liquid crystal display panel 21 is fixed to the spacer 30 through a joining layer 41 which may be made of an adhesive or the like.

In more detail, the liquid crystal display panel 21 has a structure in which a liquid crystal layer is enclosed between a pair of transparent substrates. The pair of transparent substrates may be made of a glass material, and a polarizing plate is provided on the outer surface of each transparent substrate. In the liquid crystal layer, liquid crystal molecules, made of a predetermined liquid crystal material, are dispersed. A transparent conductive film, which may be made of indium tin oxide (ITO), and an oriented film (both are not illustrated) are formed between the liquid crystal layer and each transparent substrate. Preferably, the transparent substrates between which the liquid crystal layer is enclosed may have as a low linear expansion coefficient as possible, similar to the transparent plates 12 and 22. A reason for this is that the deformation of the liquid crystal display panel 21, which is caused with the temperature change, is reduced so that stereoscopic display is made properly.

The liquid crystal display panel 21 has a plurality of pixels, and allows the intensities of light beams from these pixels to be adjusted independently of one another. In the liquid crystal display panel 21, the liquid crystal molecules of the liquid crystal layer are rotated by the application of an electric field through pixel electrodes (separated transparent conductive films). In this way, a polarization direction of incident light on the liquid crystal display panel 21 is rotated.

### (Configuration of Parallax Barrier 11)

The parallax barrier 11 is configured to allow source light from the backlight 2 toward the liquid crystal display panel 21 to pass therethrough while separating the source light into a plurality of source light beams, and then lead the source light beams to the liquid crystal display panel 21 at respective predetermined angles. The parallax barrier 11 may have, for example, a surface 11A that faces the backlight 2, and the surface 11B that is located on the opposite side of the surface 11A, or faces the transparent plate 12. The surface 11B is disposed parallel to the surface 21B of the liquid crystal display panel 21, and may be fixed to a surface 12A of the transparent plate 12 with, for example, a transparent adhesive or the like. A perimeter of the surface 12B of the transparent plate 12 which is located on the opposite side of the parallax barrier 11 is fixed to the spacer 30 through a joining layer 42 which may be made of an adhesive or the like.

The parallax barrier 11 is a liquid crystal barrier which may have a structure, for example, in which a liquid crystal layer is enclosed between a pair of transparent substrates, on each of opposing surfaces of which electrode films are selectively formed. Preferably, these transparent substrates may be configured of a transparent glass material having as a low linear expansion coefficient as possible, similar to the transparent plates 12 and 22. A reason for this is that the distortion of the parallax barrier 11, which is caused with the temperature change, is reduced so that stereoscopic display is made properly. In the parallax barrier 11, slit-shaped open-close sections 111 and 112 that allow light to pass therethrough or block light are alternately arranged, as illustrated in FIG. 1. Each of the open-close sections 111 and 112 changes its behavior through the application of a voltage to the opposing electrode films, depending on which of a normal display (two-dimensional display) and a stereoscopic display (three-dimensional display) the stereoscopic display unit 1 makes. In more detail, each open-close section 111 enters an opened state (transmission state) and a closed state (block state) upon normal display and stereoscopic display, respectively. Meanwhile, each open-close section 112 enters an opened state (transmission state) upon normal display, and performs open and close operations in a time-division manner upon stereoscopic display. For example, the open-close sections 111 and 112, as described above, may be driven in the predetermined number of groups, and this driving for each group is performed in a time-division manner.

A positional relationship between the open-close sections 111 and 112 of the parallax barrier 11 and the pixels of the liquid crystal display panel 21 specifies angels at which the source light beams are led to the pixels of the liquid crystal display panel 21. In other words, the display image light beams are emitted from the pixels of the liquid crystal display panel 21 to the viewer at angles determined by the positional relationship between the open-close sections 111 and 112 in the transmission state and the pixels. The viewer assumes a state of viewing different images with his or her right and left eyes, respectively, thereby perceiving a stereoscopic image. The angles of the display image light beams emitted from the pixels differ from one another. Therefore, the liquid crystal display panel 21 displays images corresponding to angles at which the images enter the viewer's right and left eyes, thereby realizing stereoscopic viewing.

### (Configuration of Spacer 30)

The spacer 30 is a frame that extends along the respective perimeters of the liquid crystal display panel 21 and the parallax barrier 11, for example, so as to surround the display region of the optical device 3. The spacer 30 may be configured of, for example, the same kind of a material as that of the transparent plates 12 and 22. A reason for this is that the distortion of the liquid crystal display panel 21 and the parallax barrier 11, which is caused with the surrounding temperature change due to the difference in linear expansion coefficient between the spacer 30 and each of the liquid crystal display panel 21 and the parallax barrier 11, is reduced so that the interval D is maintained properly. The spacer 30 may not necessarily have a light transmitting function. Accordingly, a material of the spacer 30 is not limited to a transparent one, and the spacer 30 may be configured of various kinds of material, including glass having low light permeability, resin, metal, and ceramic. However, desirably, the spacer 30 may be configured of a material having substantially the same linear expansion coefficient as the materials of the transparent substrates constituting the transparent plates 12 and 22, the liquid crystal display panel 21, and the parallax barrier 11 do. With the spacer 30 configured in this manner, the interval D is maintained properly.

The space IS (refer to Part (A) of FIG. 2), which is surrounded by the transparent plate 12 of the parallax separation section 10, the transparent plate 22 of the display section 20, and the spacer 30 may be, for example, sealed. In addition, desirably, an inside pressure of the space IS may be kept lower than an outside pressure thereof. This configuration prevents foreign substances from entering the space IS and reduces the variation in the interval D which is caused by the expansion and shrink of the inner air with the temperature change.

### [Operation]

An operation of the stereoscopic display unit 1 according to this embodiment will now be described. It is to be noted that the following description will be given below, regarding a case where display is made in a time division manner, as an example.

### (Outline of Overall Operation)

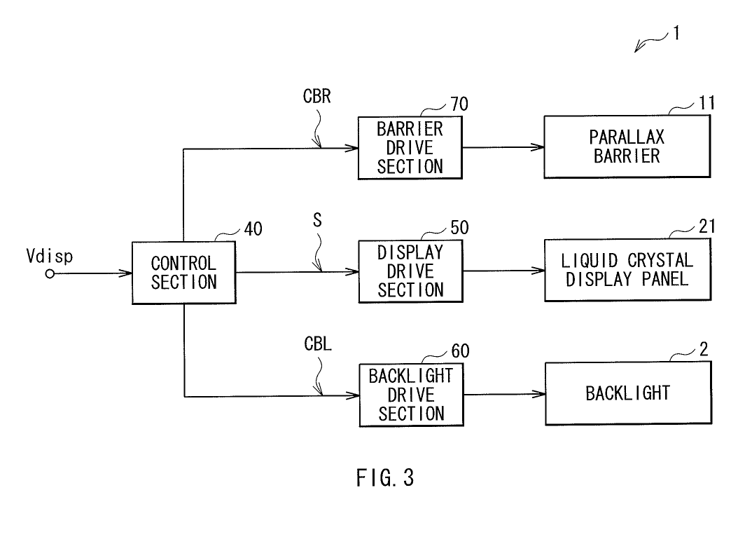

First, a description will be given of an outline of an overall operation of the stereoscopic display unit 1, with reference to FIG. 3. A control section 40 controls a display drive section 50, a backlight drive section 60, and a barrier drive section 70 so as to operate in synchronization with one another by supplying control signals to them on the basis of an image signal Vdisp supplied from an external source. The backlight drive section 60 drives the backlight 2 on the basis of a backlight control signal CBL supplied from the control section 40. The backlight 2 emits light from a whole surface thereof toward the parallax barrier 11. The barrier drive section 70 drives the parallax barrier 11 on the basis of a barrier control signal CBR supplied from the control section 40. The open-close sections 111 and 112 of the parallax barrier 11 perform the open and close operations on the basis of the barrier control signal CBR, thereby allowing source light, which has been emitted from the backlight 2 toward the liquid crystal display panel 21, to pass therethrough or blocking the source light, as appropriate. The display drive section 50 drives the liquid crystal display panel 21 on the basis of an image signal S supplied from the control section 40. The liquid crystal display panel 21 makes display by modulating the source light that has been emitted from the backlight 2 and that has passed through the parallax barrier 11.

### (Detailed Operation of Making Stereoscopic Viewing Display)

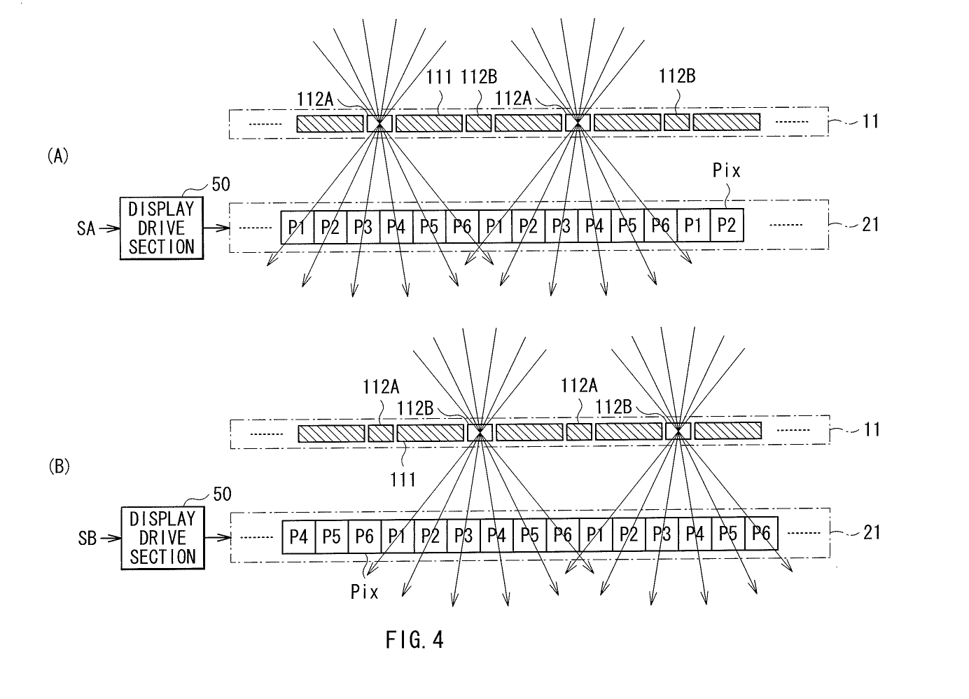

Next, a description will be given of a detailed operation of making stereoscopic display, with reference to FIGS. 4A and 4B.

FIGS. 4A and 4B illustrate exemplary operations of the display section 20 and the parallax separation section 10. Specifically, FIG. 4A illustrates a case where an image signal SA is supplied, and FIG. 4B illustrates a case where an image signal SB is supplied.

As illustrated in FIG. 4A, when the image signal SA is supplied, each pixel Pix of the liquid crystal display panel 21 displays any one of pieces of pixel information P1 to P6 that correspond to, for example, six perspective images, respectively, contained in the image signal SA. In this case, the pieces of pixel information P1 to P6 are displayed at corresponding ones of the pixels Pix which are arranged close to each open-close section 112A. When the image signal SA is supplied, the parallax barrier 11 is controlled in such a way that the open sections 112A enter an opened state (transmission state) and open sections 112B enter a closed state. The light beams output from the pixels Pix of the liquid crystal display panel 21 are output from the open-close section 112A, with the angles of the light beams being specified by the open-close section 112A. The viewer views, for example, the pixel information P3 and the pixel information P4 with his or her left eye and right eye, respectively, thereby perceiving a stereoscopic image.

Meanwhile, when the image signal SB is supplied, each pixel Pix of the liquid crystal display panel 21 displays any one of pieces of pixel information P1 to P6 that correspond to, for example, six perspective images, respectively, contained in the image signal SB, as illustrated in FIG. 4B. In this case, the pieces of pixel information P1 to P6 are displayed at corresponding ones of the pixels Pix which are arranged close to each open-close section 112B. When the image signal SB is supplied, the parallax barrier 11 is controlled in such a way that the open sections 112B enter an opened state (transmission state) and the open sections 112A enter a closed state. After light beams output from the pixels Pix of the liquid crystal display panel 21 are output from the open-close section 112B, with the angles of the light beams being specified by the open-close section 112B. The viewer views, for example, the pixel information P3 and the pixel information P4 with his or her left eye and right eye, respectively, thereby perceiving a stereoscopic image.

As described above, the viewer views different ones of the pieces of pixel information P1 to P6 with his or her left eye and right eye, respectively. Consequently, the viewer recognizes the different pieces of pixel information as a stereoscopic image. Furthermore, the images are displayed while the open-close sections 112A and 112B are alternately opened in a time-division manner. As a result, the viewer views the images displayed at locations shifted from each other while averaging the images. Thus, the stereoscopic display unit 1 achieves a resolution that is approximately twice as high as that of a display unit with the open-close sections 112A alone. In other words, the resolution of the stereoscopic display unit 1 may be approximately ⅓ (=⅙×2) of that of a two-dimensional display.

### (Effect)

Hereinafter, a description will be given of an effect which the stereoscopic display unit 1 according to this embodiment produces.

### (1) Reduction in Weight and Maintenance of Stiffness

In this embodiment, as described above, the optical device 3 has the hollow structure in which the space IS is created. Therefore, the stereoscopic display unit 1 achieves the reduction in the weight in comparison with a case of using a spacer configured of a single plate as in Japanese Unexamined Patent Application Publication No. H03-119889. In addition, the stereoscopic display unit 1 is advantageous in terms of the cost reduction. Moreover, the stereoscopic display unit 1 maintains its overall stiffness, by using the frame-structured spacer 30 sandwiched between the pair of transparent plates 12 and 22 as a reinforcement member that supports the parallax barrier 11 and the liquid crystal display panel 21. This structure suppresses the bending or distortion of the parallax barrier 11 and the liquid crystal display panel 21, thereby maintaining the interval D properly. Consequently, it is possible to realize the excellent stereoscopic display.

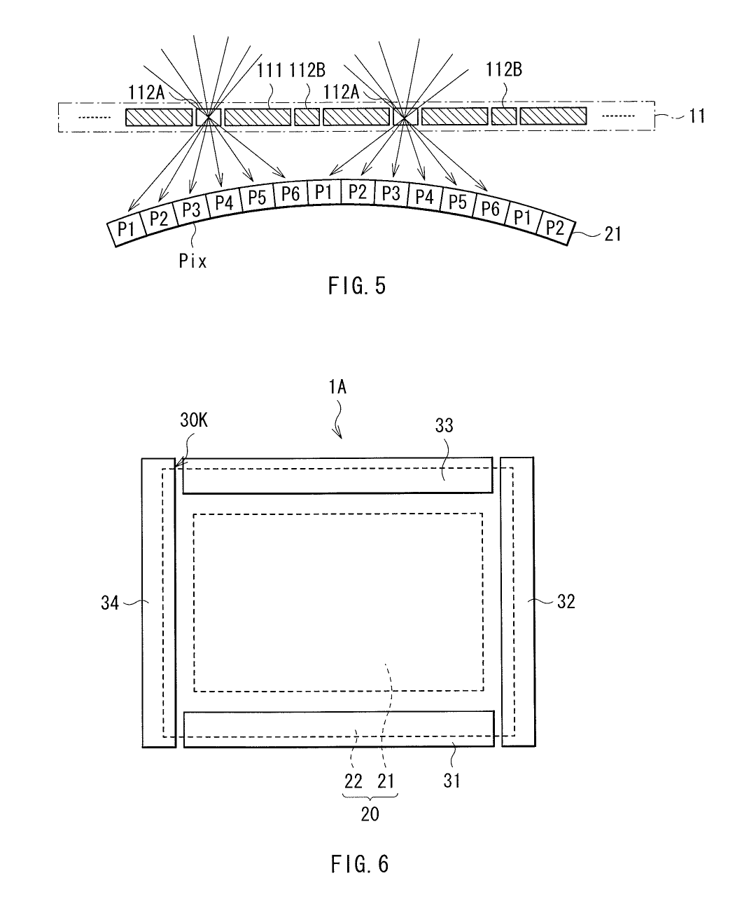

FIG. 5 illustrates a configuration in which the liquid crystal display panel 21 is deformed or distorted, and a display state of this configuration. If the liquid crystal display panel 21 is deformed as illustrated in FIG. 5, the ideal positional relationship may be broken off between the open-close sections 112A and the pixels Pix, thus failing to maintain the predetermined interval D, unlike the state illustrated in FIG. 4A or 4B. As a result, the angles of light beams traveling from the open-close sections 112A to the pixels Pix displaying the pieces of pixel information P1 to P6 are changed. In this state, the viewpoints of the images entering the viewer's right and left eyes are displaced depending on the location of the display apparatus, unlike the ideal display state illustrated in FIG. 4A or 4B. The above state may deteriorate the image, for example, by generating moire fringes or causing pseudo stereoscopy. It is to be noted that the deformation (bending or distortion) of the liquid crystal display panel 21 may be caused when the pair of transparent substrates sandwiching the liquid crystal layer has a small thickness and low stiffness.

The parallax barrier 11 also has the main structure in which the pair of transparent substrate sandwiches the liquid crystal layer. Accordingly, the parallax barrier 11 may cause the deterioration of the image, for example, due to the generation of moire fringes or the occurrence of pseudo stereoscopy, unless the transparent plate 12 is employed as a reinforcing member, similar to the liquid crystal display panel 21.

In contrast, this embodiment reduces the weight of the overall configuration and maintains the stiffness thereof by employing the structure in which the flame-structured spacer 30 is interposed between the pair of transparent plates 12 and 22.

### (2) Increase in Flexibility of Design

The stereoscopic display unit 1 allows the respective thicknesses of the interval D and the pair of transparent plates 12 and 22 to be designed independently of one another. A necessary distance of the interval D between the parallax barrier 11 and the liquid crystal display panel 21 is determined by a design based on a product specification. Accordingly, in the case where the predetermined interval D is secured in a display unit having a spacer configured of a single plate as in Japanese Unexamined Patent Application Publication No. H03-119889, a weight necessary for the display unit is fixed automatically. In contrast, the stereoscopic display unit 1 allows the respective thicknesses of the transparent plates 12 and 22 acting as reinforcing members to be determined independently of the interval D by employing the hollow structure. As a result, even when the interval D increases, the thicknesses of the transparent plates 12 and 22 do not become larger than necessary, so that the weight of the stereoscopic display unit 1 is reduced. Also, the spacer 30 is not requested to have light permeability, and therefore metal, ceramics, resin, or some other similar material is applicable to the spacer 30, because of their linear expansion coefficients.

### (3) Additional Effect

In this embodiment, the parallax barrier 11 and the liquid crystal display panel 21 may be provided on the outer surfaces 12A and 22A of the transparent plates 12 and 22, respectively. Therefore, wires connected to the parallax barrier 11 and the liquid crystal display 12 which may be intended for signal transmission, power supply, and the like may also be provided on the outer surfaces 12A and 22A, respectively. This configuration simplifies the structure of the optical device 3. Consequently, it is possible to prevent the processing steps of the optical device 3 from being complicated, and to assemble the optical device 3 relatively easily. If the parallax barrier 11 and the liquid crystal display panel 21 are provided on the inner surfaces 12B and 22B, respectively, wires for signal transmission and power supply may be also provided on the inner surfaces 12B and 22B. This configuration may involve routing the wires from the space IS to external sources. In this case, the structure of the spacer 30 and processing of sealing the space IS are prone to being complex. Hence, the first embodiment is advantageous over an embodiment having such configuration.

### MODIFICATION EXAMPLE OF FIRST EMBODIMENT (MODIFICATION EXAMPLE 1)

### (Structure)

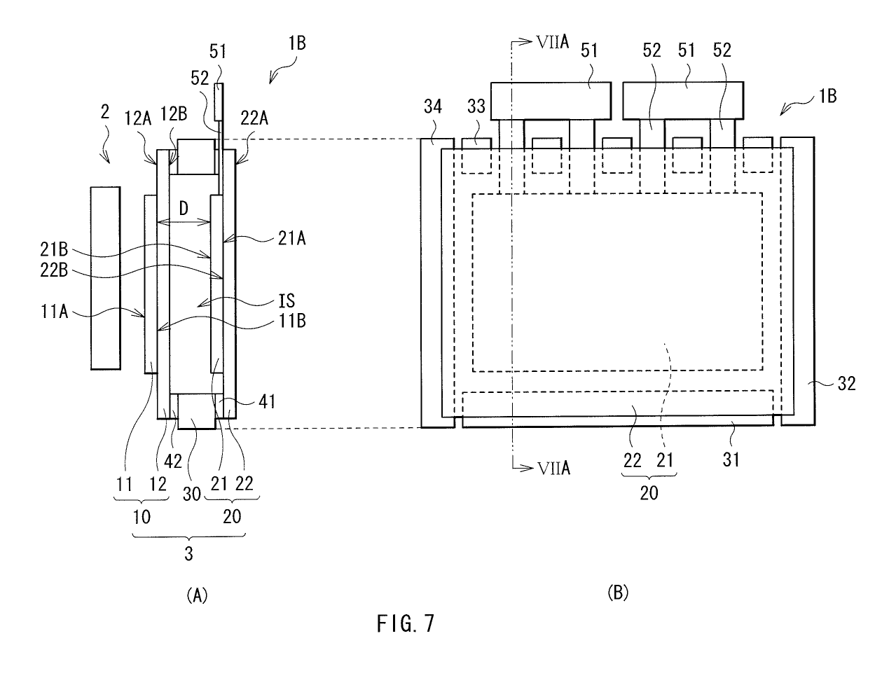

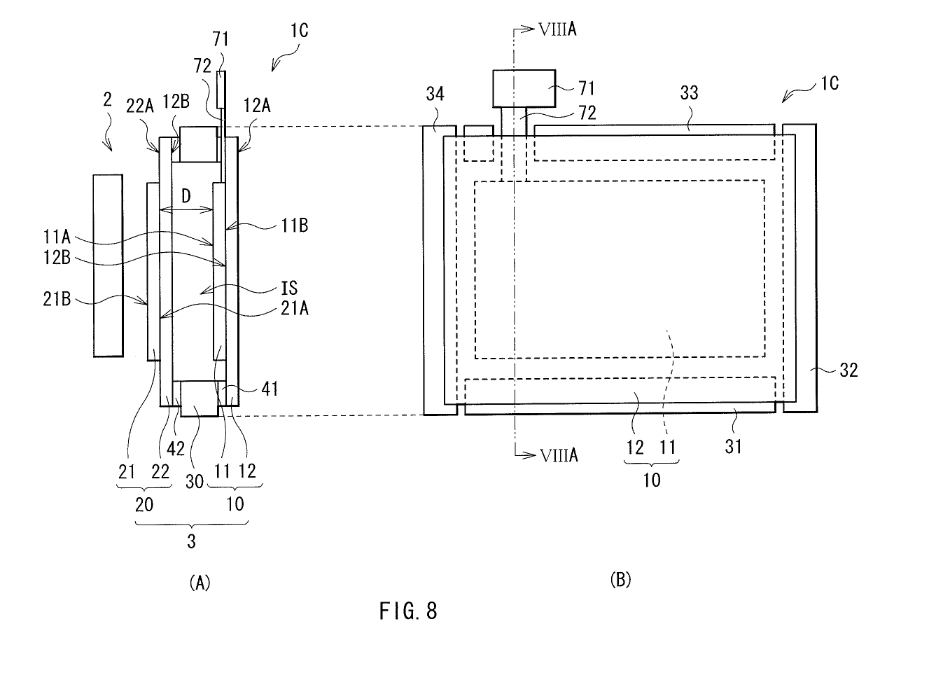

FIG. 6 is a plan view illustrating an exemplary structure of a stereoscopic display unit 1A according to a modification example of this embodiment, and corresponds to Part (B) of FIG. 2 illustrating the above stereoscopic display unit 1. In FIG. 6, the display section 20 is illustrated by dotted lines. In the stereoscopic display unit 1A, the spacer 30 of the optical device 3 includes a plurality of parts 31 to 34 separated from one another. Specifically, a gap is defined between adjacent ones of the plurality of parts 31 to 34. Accordingly, air holes 30K that cause the space IS to communicate with the exterior are formed in the spacer 30 at four locations thereof. It is to be noted that although the spacer 30 includes the four parts 31 to 34, there is no limitation on the number of parts as long as the air holes 30K are provided at one or more locations.

### (Effect)

In this modification example, with the air holes 30K, the deformation (or expansion) of the optical device 3 which is caused by the expansion of air within the space IS is avoided even when the surrounding temperature is changed (in particular, is increased). This is because the air is exhausted from the space IS to the exterior through the air holes 30K as appropriate.

### Second Embodiment

### (Overall Configuration of Stereoscopic Display Unit 1B)

Parts (A) and (B) of FIG. 7 are a cross-section view and a plan view, respectively, of an exemplary configuration of a stereoscopic display unit 1B according to a second embodiment of the present disclosure. The cross-section view in Part (A) of FIG. 7 corresponds to a cross section taken along a cutting plane line VIIA-VIIA in Part (B) of FIG. 7 and viewed in a direction along an arrow of the cutting plane line VIIA-VIIA. The stereoscopic display unit 1B has the same configuration as the above stereoscopic display unit 1 of the first embodiment does, aside from a configuration of the display section 20. In FIG. 7, the same reference numerals are assigned to components that are the same as those illustrated in FIGS. 1, 2, etc. Accordingly, the following description will be mainly focused on a configuration of the display section 20, and a description of other components will be omitted as appropriate.

In the stereoscopic display unit 1B, the parallax barrier 11 and the liquid crystal display panel 21 are provided on the surfaces 12A and 22B of the transparent plates 12 and 22, respectively, both of which face the backlight 2. In other words, the liquid crystal display panel 21 is provided within the space IS. Therefore, wires 52 through which drive substrates 51 in the display drive section 50 (see FIG. 3) supply signals and electricity to the liquid crystal display panel 21 are connected to the liquid crystal display panel 21 while being inserted into the space IS through the gaps of the parts 33 constituting the spacer 30.

### (Effect of Stereoscopic Display Unit 1B)

Even the stereoscopic display unit 1B configured above suppresses the parallax barrier 11 and the liquid crystal display panel 21 from being bent or distorted, and maintains the interval D properly. Consequently, it is possible to realize excellent stereoscopic display.

Also, in this embodiment, as described above, the parallax barrier 11 and the liquid crystal display panel 21 are provided on the surfaces 12A and 22B of the transparent plates 12 and 22, respectively, both of which face the backlight 2. With this configuration, the interval D is hardly varied as a result, even when the transparent plates 12 and 22 are slightly curved. This is because the transparent plates 12 and 22 are deformed in the same direction (for example, in a direction toward the backlight 2 or in the opposite direction). For example, in the case where the transparent plates 12 and 22 are made of the same material and have the same thickness, they behave in a similar manner. Consequently, it is possible to maintain the interval D more stably. A material of the transparent plates 12 and 22 may be a general-purpose, relatively inexpensive glass material, in addition to a glass material having a low linear expansion coefficient as described above. For this reason, the structure of this embodiment is believed to be advantageous in terms of further enlargement of screen.

Further, in this embodiment, as described above, the liquid crystal display panel 21 is disposed within the space IS. This configuration enables the transparent plate 22 as a reinforcing member to function as a cover glass for the stereoscopic display unit 1B.

### MODIFICATION EXAMPLE OF SECOND EMBODIMENT (MODIFICATION EXAMPLE 2)

### (Structure)

Parts (A) and (B) of FIG. 8 are a cross-section view and a plan view, respectively, of an exemplary configuration of a stereoscopic display unit 1C according to a modification example of this embodiment, and correspond to Parts (A) and (B) of FIG. 7, respectively, illustrating the above stereoscopic display unit 1B. In the stereoscopic display unit 1C, the optical device 3 is configured by arranging the liquid crystal display panel 21, the transparent plate 22, the spacer 30, the parallax barrier 11, and the transparent plate 12 in this order in a direction away from a location adjacent to the backlight 2. Specifically, the parallax barrier 11 is provided within the space IS. Therefore, wires 72 through which a drive substrate 71 in the barrier drive section 70 (see FIG. 3) supplies a signal and electricity to the parallax barrier 11 are connected to the parallax barrier 11 while being inserted into the space IS through the gaps of the parts 33 constituting the spacer 30. In the liquid crystal display panel 21, the surface 21A on which an image is displayed is fixed to the surface 22A of the transparent plate 22, and the surface 21B is disposed so as to face the backlight 2. Meanwhile, in the parallax barrier 11, the surface 11A faces the liquid crystal display panel 21, and the surface 11B that is located on the opposite side of the surface 11A, or faces the viewer, is fixed to the surface 12B of the transparent plate 12.

### (Function)

In the stereoscopic display unit 1C, first, the backlight drive section 60 drives the backlight 2 on the basis of the backlight control signal CBL supplied from the control section 40. The backlight 2 emits light from a whole surface thereof toward the display section 20. The display drive section 50 drives the display section 20 on the basis of the image signal S supplied from the control section 40. The display section 20 makes display by modulating the light emitted from the backlight 2. The barrier drive section 70 drives the parallax barrier 11 on the basis of the barrier control signal CBR supplied from the control section 40. Each of the open-close sections 111 and 112 of the parallax barrier 11 performs open and close operations on the basis of the barrier control signal CBR, thereby allowing the light that has been emitted from the backlight 2 and has passed through the display section 20 to pass through or blocking the light.

### EFFECT OF THIS MODIFICATION EXAMPLE

Even the stereoscopic display unit 1C of this modification example also makes it possible to greatly reduce the variation in the interval D, similar to the above stereoscopic display unit 1B. This is because even when the transparent plates 12 and 22 are slightly curved, they are deformed in the same direction (for example, in a direction toward the backlight 2 or in the opposite direction). Further, in this modification example, as described above, the parallax barrier 11 is disposed within the space IS. This configuration enables the transparent plate 12 as a reinforcing member to function as a cover glass for the stereoscopic display unit 1C. Furthermore, since an amount of information necessary to drive the parallax barrier 11 is typically smaller than that necessary to drive the liquid crystal display panel 21, the number of wires 72 is smaller than that of the wires 52. Consequently, it is possible to reduce the number of gaps provided in the spacer 30, thereby simplifying the structure of the spacer 30.

Up to this point, the present technology has been described by using the example embodiments and the modification examples thereof (hereinafter, referred to as “the above embodiments and the like.” However, the present technology is not limited to the above embodiments and the like, and various modifications thereof may be made. For example, the variable parallax barrier that uses the liquid crystal element and that performs time-divisional driving is used as the parallax separation section of the above embodiments and the like. However, there is no specific limitation on the parallax separation section of the present technology. If the time-divisional driving is unnecessary, a fixed barrier in which light blocking portions and light transmission sections are alternately arranged may be used as the parallax separation section. For example, each light blocking portion may be configured by disposing a black substance that blocks light, a thin-film-shaped metal that reflects light, or some other light blocking material on a transparent flat plate, and each light transmission section may be formed in a slit shape and have light permeability. Alternatively, a lenticular lens in which a plurality of cylindrical lenses are arranged may be used as the parallax separation section. In sum, there is no limitation on the parallax separation section, as long as the parallax separation section optically splits p-number of perspective images displayed on the display section so as to realize stereoscopic viewing at p-number of viewpoints.

In FIGS. 1, 2, and 7, the backlight 2, the parallax separation section 10, and the display section 20 are arranged in this order in a direction toward the viewer. However, the arrangement order of the parallax separation section 10 and the display section 20 may be inverted. Likewise, although the backlight 2, the display section 20, and the parallax separation section 10 are arranged in this order in FIG. 8, the arrangement order of the parallax separation section 10 and the display section 20 may be inverted.

In the above embodiments and the like, the color liquid crystal display using the backlight is exemplified as the display section. However, there is no specific limitation on the display section of the present technology. Alternatively, for example, a display using an organic EL element, a plasma display, or the like may be used. In this case, the backlight drive section and the backlight are unnecessary.

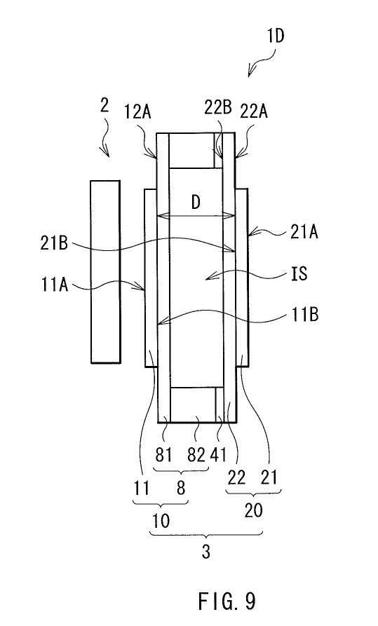

In the above embodiments and the like, both of the display section and the parallax separation section are provided independently of the spacer section. However, in the present technology, the spacer section and either of the display section and the parallax separation section may be integrated, for example, as in another modification example (modification example 3) illustrated in FIG. 9. In a stereoscopic display unit 1D illustrated in FIG. 9, the optical device 3 employs a member 8 that integrates a spacer and a transparent plate supporting the parallax barrier 11. Specifically, in the stereoscopic display unit 1D, a bottom plate section 81 functions as the transparent plate enforcing the parallax barrier 11, and a frame section 82 functions as the spacer.

Furthermore, the technology encompasses any possible combination of some or all of the various embodiments described herein and incorporated herein.

It is possible to achieve at least the following configurations from the above-described example embodiments of the disclosure.
(1) A stereoscopic display optical device, including:

a display section;

a parallax separation section disposed to face the display section; and

a spacer section sandwiched between the display section and the parallax separation section, and extending along respective perimeters of the display section and the parallax separation section.
(2) The stereoscopic display optical device according to (1), wherein

the display section includes a first transparent plate, and a liquid crystal display panel supported by the first transparent plate, and

the parallax separation section includes a second transparent plate, and a liquid crystal barrier supported by the second transparent plate.
(3) The stereoscopic display optical device according to (2),

wherein the liquid crystal display panel is provided on a surface, of the first transparent plate, that faces the parallax separation section, and the liquid crystal barrier is provided on a surface, of the second transparent plate, that is located on an opposite side of the display section, or

wherein the liquid crystal display panel is provided on a surface, of the first transparent plate, that is located on an opposite side of the parallax separation section, and the liquid crystal barrier is provided on a surface, of the second transparent plate, that faces the display section.
(4) The stereoscopic display optical device according to (2) or (3), wherein the first transparent plate, the second transparent plate, and the spacer section are made of the same kind of material.
(5) The stereoscopic display optical device according to (4), wherein

the first transparent plate, the second transparent plate, and the spacer section are made of the same kind of glass, and

each of the first transparent plate and the second transparent plate is adhered to the spacer section with an adhesive.
(6) The stereoscopic display optical device according to any one of (1) to (5), wherein the spacer section includes a plurality of separated parts.
(7) The stereoscopic display optical device according to any one of (1) to (5), wherein

the display section, the parallax separation section, and the spacer section form a space that is surrounded thereby and is sealed, and

the space has an inner pressure that is kept lower than an outside pressure thereof
(8) A stereoscopic display unit provided with a light source and a stereoscopic display optical device that displays a stereoscopic image by utilizing light from the light source, the stereoscopic display optical device including:

a display section;

a parallax separation section disposed to face the display section; and

a spacer section sandwiched between the display section and the parallax separation section, and extending along respective perimeters of the display section and the parallax separation section.
(9) The stereoscopic display unit according to (8), wherein

the display section includes a first transparent plate, and a liquid crystal display panel supported by the first transparent plate, and

the parallax separation section includes a second transparent plate, and a liquid crystal barrier supported by the second transparent plate.
(10) The stereoscopic display unit according to (9),

wherein the liquid crystal display panel is provided on a surface, of the first transparent plate, that faces the parallax separation section, and the liquid crystal barrier is provided on a surface, of the second transparent plate, that is located on an opposite side of the display section, or

wherein the liquid crystal display panel is provided on a surface, of the first transparent plate, that is located on an opposite side of the parallax separation section, and the liquid crystal barrier is provided on a surface, of the second transparent plate, that faces the display section.
(11) The stereoscopic display unit according to (10), wherein

the light source, the parallax separation section, and the display section are arranged in this order, and

the liquid crystal display panel is provided on the surface, of the first transparent plate, that faces the parallax separation section.

The present disclosure contains subject matter related to that disclosed in Japanese Priority Patent Application JP 2012-136905 filed in the Japan Patent Office on Jun. 18, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof

What is claimed is:

1. A stereoscopic display optical device, comprising:
a display section;
a parallax separation section disposed to face the display section; and
a spacer section sandwiched between the display section and the parallax separation section, and extending along respective perimeters of the display section and the parallax separation section.

2. The stereoscopic display optical device according to claim 1, wherein
the display section includes a first transparent plate, and a liquid crystal display panel supported by the first transparent plate, and
the parallax separation section includes a second transparent plate, and a liquid crystal barrier supported by the second transparent plate.

3. The stereoscopic display optical device according to claim 2,
wherein the liquid crystal display panel is provided on a surface, of the first transparent plate, that faces the parallax separation section, and the liquid crystal barrier is provided on a surface, of the second transparent plate, that is located on an opposite side of the display section, or
wherein the liquid crystal display panel is provided on a surface, of the first transparent plate, that is located on an opposite side of the parallax separation section, and the liquid crystal barrier is provided on a surface, of the second transparent plate, that faces the display section.

4. The stereoscopic display optical device according to claim 2, wherein the first transparent plate, the second transparent plate, and the spacer section are made of the same kind of material.

5. The stereoscopic display optical device according to claim 4, wherein
the first transparent plate, the second transparent plate, and the spacer section are made of the same kind of glass, and
each of the first transparent plate and the second transparent plate is adhered to the spacer section with an adhesive.

6. The stereoscopic display optical device according to claim 1, wherein the spacer section includes a plurality of separated parts.

7. The stereoscopic display optical device according to claim 1, wherein
the display section, the parallax separation section, and the spacer section form a space that is surrounded thereby and is sealed, and
the space has an inner pressure that is kept lower than an outside pressure thereof

8. A stereoscopic display unit provided with a light source and a stereoscopic display optical device that displays a stereoscopic image by utilizing light from the light source, the stereoscopic display optical device comprising:
a display section;
a parallax separation section disposed to face the display section; and
a spacer section sandwiched between the display section and the parallax separation section, and extending along respective perimeters of the display section and the parallax separation section.

9. The stereoscopic display unit according to claim 8, wherein
the display section includes a first transparent plate, and a liquid crystal display panel supported by the first transparent plate, and
the parallax separation section includes a second transparent plate, and a liquid crystal barrier supported by the second transparent plate.

10. The stereoscopic display unit according to claim 9,
wherein the liquid crystal display panel is provided on a surface, of the first transparent plate, that faces the parallax separation section, and the liquid crystal barrier is provided on a surface, of the second transparent plate, that is located on an opposite side of the display section, or
wherein the liquid crystal display panel is provided on a surface, of the first transparent plate, that is located on an opposite side of the parallax separation section, and the liquid crystal barrier is provided on a surface, of the second transparent plate, that faces the display section.

11. The stereoscopic display unit according to claim 10, wherein
the light source, the parallax separation section, and the display section are arranged in this order, and
the liquid crystal display panel is provided on the surface, of the first transparent plate, that faces the parallax separation section.
